(19) United States
(12) Patent Application Publication
(10) Pub. No.: US 2024/0092206 A1
(43) Pub. Date: Mar. 21, 2024

(54) EV CHARGER SYSTEM POWER PLATFORM

(71) Applicant: SHOALS TECHNOLOGIES GROUP, LLC, Portland, TN (US)

(72) Inventors: Steven P. GREENWELL, Portland, TN (US); Jeffrey O. CANTADA, Portland, TN (US)

(21) Appl. No.: 18/521,934

(22) Filed: Nov. 28, 2023

Related U.S. Application Data
(63) Continuation-in-part of application No. 18/309,765, filed on Apr. 28, 2023.
(60) Provisional application No. 63/363,924, filed on Apr. 29, 2022.
(60) Provisional application No. 63/367,022, filed on Jun. 24, 2022.
(60) Provisional application No. 63/379,616, filed on Oct. 14, 2022.

(51) Int. Cl. B60L 53/31

(52) U.S. Cl. CPC B60L 53/31; B60L 53/18

(57) ABSTRACT

In an example, an electrical vehicle (EV) charger system power platform includes a housing, a transformer, a distribution board, and an electrical safety switch. The housing encloses a volume. The transformer is disposed within the volume and is configured to be electrically coupled to a power source and to generate output power from input power received from the power source. The distribution board is disposed within the volume and is electrically coupled to an output of the transformer. The electrical safety switch is disposed within the volume and is electrically coupled to an input of the transformer and configured to be electrically coupled to the power source.

### CROSS-REFERENCE TO RELATED APPLICATIONS

This application is a continuation-in-part of U.S. application Ser. No. 18/309,765 filed on Apr. 28, 2023, which claims the benefit of and priority to U.S. Provisional App. No. 63/363,924 filed on Apr. 29, 2022, U.S. Provisional App. No. 63/367,022 filed on Jun. 24, 2022, and U.S. Provisional App. No. 63/379,616 filed on Oct. 14, 2022, each of which is incorporated herein by reference in its entirety.

### FIELD

Embodiments described herein relate to an electric vehicle (EV) charger system power platform.

### BACKGROUND

Unless otherwise indicated in the present disclosure, the materials described in the present disclosure are not prior art to the claims in the present application and are not admitted to be prior art by inclusion in this section.

Typical electric vehicles (EVs) operate on large on-board energy storage cells or rechargeable batteries. EV battery capacity limits the distances EVs can travel on a single charge from and/or between a user's home EV charger system and commercial EV charger systems (e.g., charging stations). Commercial EV charger infrastructure has historically included sparsely located EV charger systems at haphazard or ad hoc locations. The sparsity of commercial EV charger infrastructure is an impediment to the widespread adoption of EVs.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, an electrical vehicle (EV) charger system power platform includes a housing, a transformer, a distribution board, and an electrical safety switch. The housing encloses a volume. The transformer is disposed within the volume and is configured to be electrically coupled to a power source and to generate output power from input power received from the power source. The distribution board is disposed within the volume and is electrically coupled to an output of the transformer. The electrical safety switch is disposed within the volume and is electrically coupled to an input of the transformer and configured to be electrically coupled to the power source.

In another example embodiment, a method includes positioning a transformer within a volume enclosed by a housing of an electric vehicle (EV) charger system power platform at an assembly site that is different than an installation site of the EV charger system power platform. The method includes positioning a distribution board within the volume at the assembly site. The method includes electrically coupling the distribution board to an output of the transformer at the assembly site. The method includes positioning an electrical safety switch within the volume at the assembly site. The method includes electrically coupling the electrical safety switch to an input of the transformer at the assembly site. The housing, the transformer, the distribution board, and the electrical safety switch collectively form the EV charger system power platform.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates a block diagram of an example EV charger system;

FIG. 1B illustrates a block diagram of another example EV charger system;

FIG. 1C illustrates a block diagram of another example EV charger system;

FIG. 2 illustrates a perspective view of another example EV charger system;

FIGS. 3A-3B illustrate an example cable management system that may be included in the system of FIG. 2;

FIG. 4 illustrates a lead assembly including a single drop line per electrical nexus with a fuse in line with the drop lines;

FIG. 5 illustrates dual drop lines associated with an electrical nexus; and

FIGS. 6A and 6B are perspective views of EV charger system power platforms, all arranged in accordance with at least one embodiment described herein.

### DESCRIPTION OF EMBODIMENTS

Approximately half of an EV infrastructure deployment cost is associated with temporal aspects of the deployment: power entry equipment, cables, skids, extensive civil work, and long cable runs and connectors. To meet EV deployment goals, charge point operators need to speed deployment while simultaneously reducing costs. Embodiments herein relate to an EV charger system and more particularly to an EV charger system power platform having components that may reduce installation times and/or costs compared to other EV charger systems. The power platform, the system, and/or components of the foregoing described herein may be preassembled and/or quickly assembled using modular components. The modular components may cost less, use less site preparation prior to installation, be readily portable, and/or offer availability to change scale in an amount of EV chargers supported.

Alternatively or additionally, the power platform may include a housing that encloses disconnect (e.g., an electrical safety switch), a transformer, a panelboard (or distribution board), and/or other components. The housing may include a single large enclosure and/or a set of modular enclosures bayed together. The components enclosed in the housing may be used to convert incoming AC or DC power to a secondary AC or DC power for distribution to EV chargers. All components of the power platform may be electrically coupled together via wiring at a facility (e.g., a manufacturing facility) prior to installing the power platform at an installation site. The housing may provide a transition to an above-ground raceway that houses power cables to carry power from the power platform to external individual EV charger platforms. Alternatively, the housing may be mounted on a base platform which may provide a transition to the above-ground raceway. The use of such power platforms and above-ground raceways as described herein may make installation easier and less costly, e.g., by preventing an installer from having to install individual components on-site at the installation site and run underground trenches for wiring, thus greatly reducing time and costs.

Embodiments of the present disclosure will be explained with reference to the accompanying drawings.

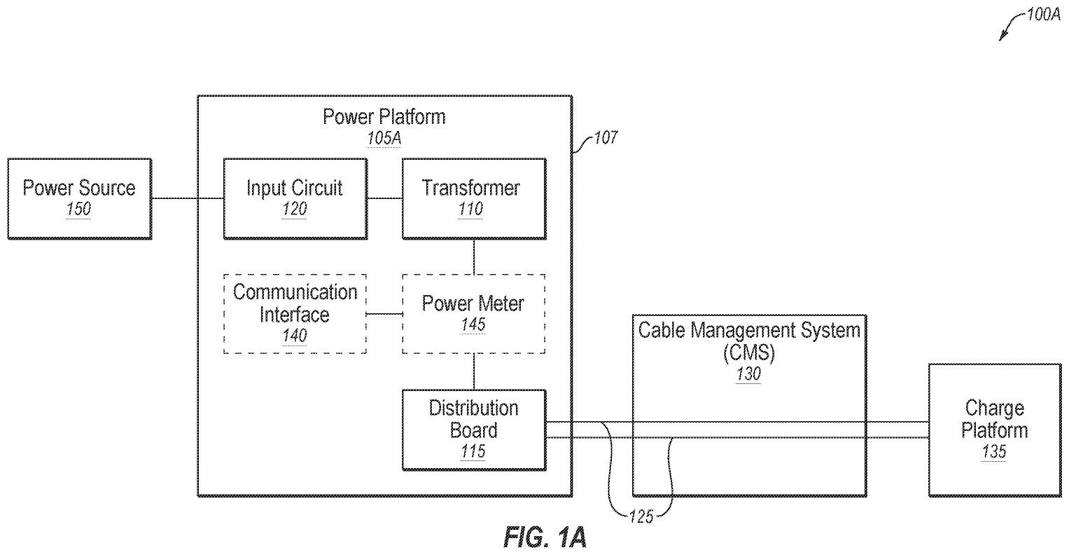

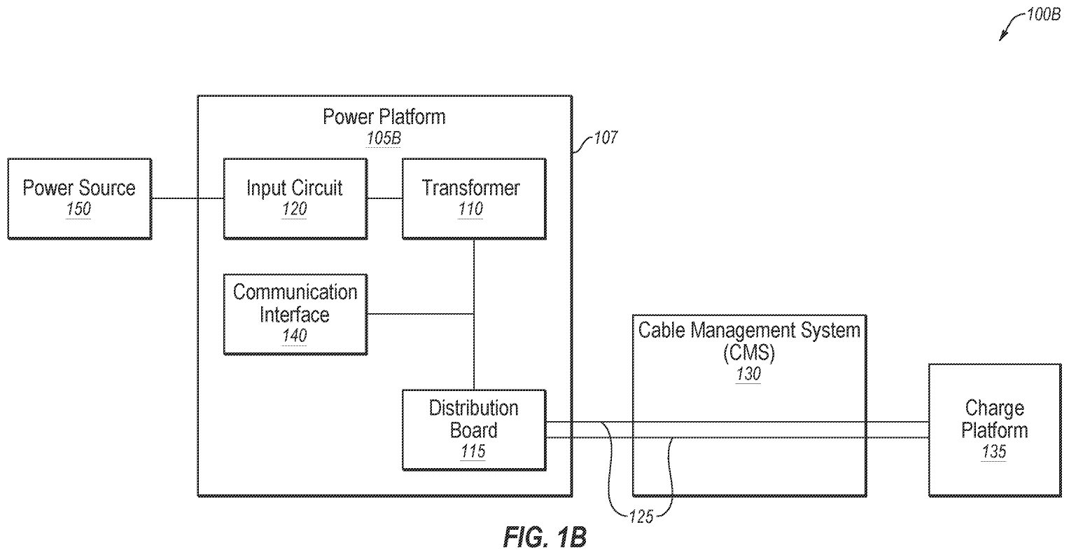

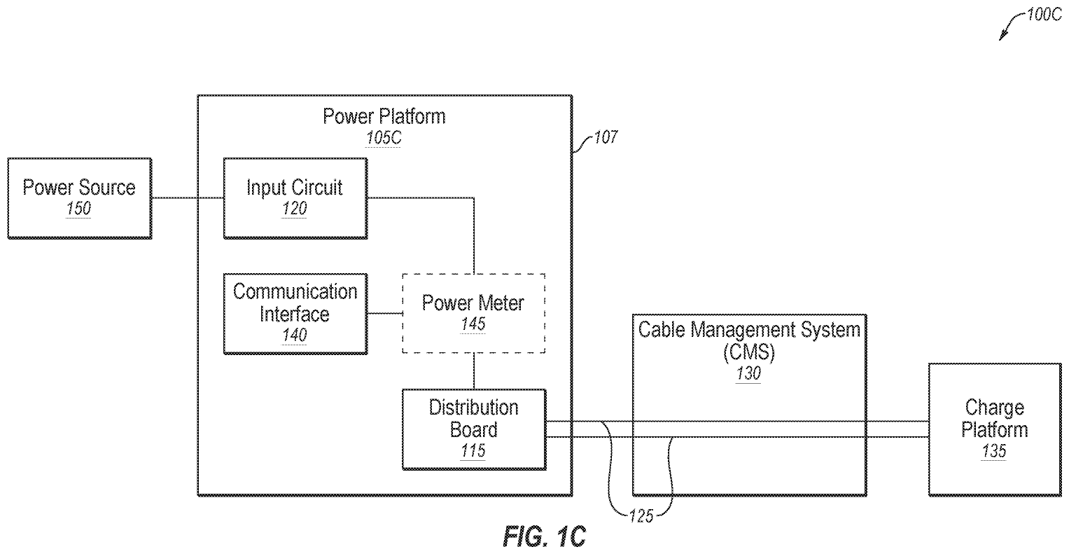

FIG. 1A illustrates a block diagram of an example EV charger system 100A (hereinafter “system 100A”), arranged in accordance with at least one embodiment described herein. In some embodiments, the system 100A may include an EV charger system power platform 105A (hereinafter “power platform 105A”), two or more lead assemblies 125, a cable management system (CMS) 130, and one or more charger platforms 135. The power platform 105A may include a base or housing 107, a transformer 110, a distribution board 115, an input circuit 120, a communication interface 140, and/or a power meter 145. The communication interface 140 and the power meter 145 are shown in dashed lines in FIG. 1A to indicate that each of the communication interface 140 and the power meter 145 is optional, i.e., the communication interface 140 and the power meter 145 may be independently included in the power platform 105A or omitted therefrom.

In general, the power platform 105A may receive and condition power from a power source 150 for use by the charger platform 135 to charge an EV. The distribution board 115 may provide electrical protection for the CMS 130 and/or the charger platforms 135. The lead assemblies 125 electrically couple the power platform 105A to the charger platforms 135. In some embodiments, the system 100A may be a direct current (DC) powered system. For example, one lead assembly 125 may be a positive lead assembly connected to a positive lead of each charger platform 135 and one lead assembly 125 may be a negative lead assembly connected to a negative lead of each charger platform 135. In some embodiments, the system 100A may be an alternating current (AC) powered system. For example, the lead assemblies 125 may be arranged to support single phase AC power (e.g., using a first lead assembly and a second lead assembly) and/or arranged to support three phase AC power (e.g., using a first lead assembly, a second lead assembly, a third lead assembly, and a neutral line).

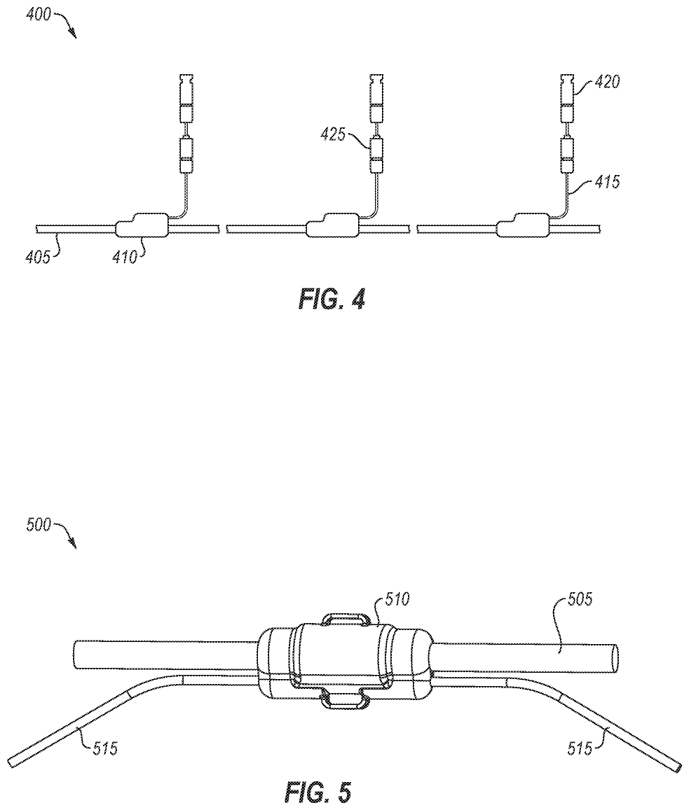

In these and other embodiments, the lead assemblies 125 may include a Lead Assembly as illustrated in FIGS. 4 and 5 of the present application and further described in U.S. Pat. No. 10,992,254 issued Apr. 27, 2021, and titled LEAD ASSEMBLY FOR CONNECTING SOLAR PANEL ARRAYS TO INVERTER, which is incorporated herein by reference in its entirety for all purposes.

Alternatively, or additionally, the lead assemblies 125 may include one or more “home run” cables, distribution cables, or power cables. The home run cables may electrically couple the power platform 105A to the charger platforms 135, where each charger platform of the charger platforms 135 may include a distinct home run cable which may electrically couple to the power platform 105A.

Alternatively, or additionally, one of the lead assemblies 125 may be the current supply conveying the output power from the power platform 105A to the charger platforms 135 and the other lead assembly 125 may be the current return. The CMS 130 may enclose and protect the lead assemblies 125, enabling above-ground wiring runs that do not require the time or cost of trenching and/or fishing wiring through conduit. The charger platforms 135 are configured to charge EVs, or more particularly batteries of the EVs.

The power platform 105A may be configured to receive input power, e.g., from the power source 150, and generate output power for operation of the charger platforms 135. For example, the power platform 105A may receive and transform an input power having a first current and voltage to an output power having a second current and voltage that is different from the first current and voltage. Instead of or in addition to transforming voltage, the power platform 105A may convert AC input power to DC output power, in which case the power platform 105A may be or include an AC-to-DC converter, or may convert DC power to AC power, in which case the power platform 105A may be or include a DC-to-AC converter. In some embodiments, the output power may be or include DC power to charge batteries, such as EV batteries. In some embodiments, the output power may be or include AC power provided to the charger platforms 135 which may convert the AC power to DC power to charge EV batteries.

In some embodiments, the power platform 105A may include interlocking, plug-and-play components that may be modularly assembled. For example, the power platform 105A may include two or more of the transformer 110, the distribution board 115, the input circuit 120, the communication interface 140, and/or the power meter 145, each of which may interlock with one or more of the other components and/or the base or housing 107. In embodiments in which the base or housing 107 is a base, the base 107 may include a metal platform, a skid, or the like. In embodiments in which the base or housing 107 is a housing, the housing 107 may include a metal housing or housing of other material(s) with one or more access panels, such as a first access panel to access the input circuit 120, a second access panel to access the transformer 110, a third access panel to access the distribution board 115, or the like. The base or housing 107 is referred to hereinafter as the base 107 when the base or housing 107 is the base and as the housing 107 when the base or housing 107 is the housing.

In some embodiments, the transformer 110, the distribution board 115, the input circuit 120, the communication interface 140, and/or the power meter 145 may be coupled to the base 107 and/or may be assembled to form the power platform 105A prior to installation of the power platform 105A in an operational location. For example, the transformer 110, the distribution board 115, the input circuit 120, the communication interface 140, and/or the power meter 145 may be assembled into the power platform 105A in a factory setting prior to the deployment of the power platform 105A for use in the operational location. Alternatively, or additionally, the transformer 110, the distribution board 115, the input circuit 120, the communication interface 140, and/or the power meter 145 may be assembled as part of an installation of the power platform 105A for use in the operational location and/or at other time or location apart from a factory and/or operational location. For example, each of the transformer 110, the distribution board 115, the input circuit 120, the communication interface 140, and/or the power meter 145 may be received at the operational location (or other location) and may be assembled into the power platform 105A as part of and/or in advance of an installation thereof.

In some embodiments, the power platform 105A may include custom, semi-custom, or third-party components assembled within a single large enclosure. For example, one or more of the transformer 110, the distribution board 115, the input circuit 120, the communication interface 140, and/or the power meter 145 may be custom-built or may include third-party components modified, or customized, for the power platform 105A. As a particular example, the transformer 110 may include the transformer circuitry of a third-party product removed from a housing of the third-party product, which is an example of a semi-custom component.

In an example embodiment, the power platform 105A is assembled and/or installed as follows, not necessarily in the following order or including every single step. The transformer 110 is coupled to the base 107 at an assembly site that is different than an installation site of the power platform 105A. The power meter 145 is coupled to the base 107 and is electrically coupled to the transformer 110 at the assembly site. The distribution board is coupled to the base 107 at the assembly site. The distribution board 115 is electrically coupled through the power meter 145 to the transformer 110 at the assembly site. The communication interface 140 is coupled to the base 107 and is electrically coupled to the power meter 145 at the assembly site. The base 107, the transformer 110, the power meter 145, the distribution board 115, and the communication interface 140 (and/or other components such as the input circuit 120) collectively form the power platform 105A. After assembly at the assembly site, in some embodiments the assembled power platform 105A may be transported to the installation site and then may be installed at the installation site. Installing the power platform 105A at the installation site may include electrically coupling the power platform 105A, and more specifically the transformer 110 (e.g., through the input circuit 120), to the power source 150 and/or mechanically coupling the power platform 105A to the installation site (e.g., using screws, earth screws, masonry screws, bolts, lag bolts, anchors, concrete anchors, expanding anchors, nails, or the like).

In another example embodiment, the power platform 105A is assembled and/or installed as follows, not necessarily in the following order or including every single step. The transformer 110 is positioned within a volume enclosed by the housing 107 of the power platform 105A at an assembly site that is different than an installation site of the power platform 105A. The distribution board 115 is positioned within the volume at the assembly site. The distribution board 115 is electrically coupled to an output of the transformer 110 at the assembly site. An electrical safety switch such as may be included in the input circuit 120, and/or the entire input circuit 120, is positioned within the volume at the assembly site. The electrical safety switch is electrically coupled to an input of the transformer 110 at the assembly site. The housing 107, the transformer 110, the distribution board 115, and the electrical safety switch collectively form the power platform 105A. In some embodiments, the method of assembling and/or installing the power platform 105A may further include transporting the power platform 105A to the installation site and installing the power platform 105A at the installation site. Installing the power platform 105A at the installation site may include electrically coupling the power platform 105A to the power source 150 and mechanically coupling the power platform 105A to the installation site. Mechanically coupling the power platform 105A to the installation site may include mechanically coupling the power platform 105A to a surface and/or structure at the installation site using at least one of screws, earth screws, masonry screws, bolts, lag bolts, anchors, concrete anchors, expanding anchors, or nails. In some embodiments, the method of assembling and/or installing the power platform 105A may further include positioning the power meter 145 within the volume and electrically coupling the power meter 145 between the transformer 110 and the distribution board 115 at the assembly site, or positioning the communication interface 140 within the volume and communicatively coupling the communication interface 140 to the power platform 105A at the assembly site.

In some embodiments, one or more electrical lines may electrically couple the transformer 110, the distribution board 115, the input circuit 120, the communication interface 140, and the power meter 145 of the power platform 105A. Alternatively, or additionally, the one or more electrical lines may individually or collectively couple the transformer 110, the distribution board 115, the input circuit 120, the communication interface 140, and the power meter 145 to a feeder cable of the lead assemblies 125, such as the feeder cable 405 of FIG. 4. In some embodiments, a jumper may be coupled between the one or more electrical lines and the feeder cable of the lead assemblies 125. Additional details associated with the feeder cable and/or jumper and the operation thereof are further disclosed in and described with respect to FIG. 4.

In some embodiments, the transformer 110 of the power platform 105A may be configured to perform a transformation of an input power to an output power. For example, an input AC power may be received having a first voltage and current and the transformer 110 may convert the input AC power to an output AC or DC power having a second voltage and current that are different than the first voltage and current. In these and other embodiments, the transformer 110 may be electrically coupled to and receive input power from the power source 150 which may include a solar array, an electrical grid, or other power source. For example, the transformer 110 may include an EATON 300 kilovolt-ampere (kVA) general purpose ventilated transformer (item number V48M28T33EE) having a primary voltage of 480 volts (V) and a secondary voltage of 208 Y/120 V. The forgoing transformer is provided only as an example, as the transformer 110 may include any other transformer which may include the same or different primary voltage, secondary voltage, make, and/or model.

In some embodiments, the distribution board 115 distributes output power from the transformer 110 to the charger platform(s) 135 through the lead assemblies 125 and may generally include electrical supply components, including utility/supply/load conductors (e.g., wires or busbars), load side circuit breakers (e.g., one for each lead assembly 125), or the like, electrically coupled between the power platform 105A and the lead assemblies 125. The charger platform(s) 135 is(are) an example of a load of the power platform 105A. In other embodiments, the power platform 105A may have a different load.

Each load side circuit breaker of the distribution board 115 may be electrically coupled between the transformer 110 and a corresponding lead assembly 125. Each load side circuit breaker may include an electrical switch that includes an open configuration and a closed configuration. In the open configuration of a given load side circuit breaker, the transformer 110 may be electrically decoupled from a corresponding lead assembly 125 and a set of one or more corresponding charger platforms 135 that are all electrically coupled to the lead assembly 125. In the closed configuration of the given load side circuit breaker, the transformer 110 may be electrically coupled to the corresponding lead assembly 125 and the set of corresponding charger platforms 135. In these and other embodiments, the load side circuit breakers of the distribution board 115 may be configured to protect at least the lead assemblies 125, such as from a short circuit or an overcurrent, by tripping and disconnecting the lead assemblies 125 from the power platform 105A.

Each load side circuit breaker may be tripped (switched from closed to open) and/or reset (e.g., switched from open to closed) automatically or manually. For example, a given load side circuit breaker may trip automatically in response to an over current condition or short circuit to prevent or reduce damage to the system 100A or EV(s) being charged and/or may be reset automatically when the over current condition or short circuit is resolved. As another example, a given load side circuit breaker may be tripped manually by a laborer or other person to inspect, service, or otherwise interact with the lead assemblies 125, a set of corresponding charger platforms 135, and/or other component downstream of the load side circuit breaker, and may be reset manually by the laborer or other person when finished with inspecting, servicing, or otherwise interacting with the lead assemblies 125, the set of corresponding charger platforms 135, and/or other component downstream of the load side circuit breaker.

In some embodiments, the input circuit 120 may be electrically coupled between the transformer 110 and the power source 150. The input circuit 120 may include an electrical safety switch, a main lug only pull section, a disconnect panel, a 208 V panel on a quick connect board (QCB), or other suitable input circuit. When implemented as an electrical safety switch or disconnect panel (that may include, e.g., a circuit breaker), the input circuit 120 may include an electrical switch that includes an open configuration and a closed configuration. In the open configuration, the transformer 110 may be electrically decoupled from the power source 150. In the closed configuration, the transformer 110 may be electrically coupled to the power source 150.

In some embodiments, the electrical switch of the input circuit 120 may be manually operated by a user. For example, the user may disconnect the power platform 105A from the power source 150 by setting the electrical switch of the input circuit 120 to the open configuration, which may permit the user to safely service or otherwise interact with the transformer 110 and/or any electrical component downstream therefrom. In another example, the user may transition the electrical switch of the input circuit 120 from the open configuration to the closed configuration. Alternatively, or additionally, the electrical switch of the input circuit 120 may be automatically operated, such as in response to a catalyst. For example, in response to the transformer 110 becoming damaged or inoperable or the input circuit 120 detecting an overcurrent, the electrical switch of the input circuit 120 may transition from the closed configuration to the open configuration, which may reduce or prevent damage to the transformer 110 and/or other components in the system 100A. In another example, after a period of time, or in response to a signal from the transformer 110 or other components in the system 100A, the electrical switch of the input circuit 120 may transition from an open configuration to a closed configuration. In some embodiments in which the input circuit 120 includes an electrical safety switch, the input circuit 120 may include a CUTLER HAMMER DH Series safety switch (part number DH365FRK) having an operating voltage of 600 V and a current rating of 400 amps (A), or other suitable electrical safety switch.

The power meter 145 may be coupled to the base 107 and electrically coupled to and between the transformer 110 and the distribution board 115. The power meter 145 may be configured to measure power consumption or usage through the power platform 105A. In some embodiments, the power meter 145 records consumption or usage and communicates the information to a power utility for monitoring and billing. For example, the power meter 145 may communicate the information to the power utility via the communication interface 140.

The communication interface 140 may communicatively couple the power platform 105A to a communication network (hereinafter “network”). In general, the network may include one or more wide area networks (WANs) and/or local area networks (LANs) that enable the power platform 105A to communicate with other entities (e.g., a server of or associated with the power utility). In some embodiments, the network may include the Internet, including a global internetwork formed by logical and physical connections between multiple WANs and/or LANs. Alternately or additionally, the network may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network may also include servers that enable one type of network to interface with another type of network. Accordingly, the communication interface 140 may include an Ethernet chip, a Wi-Fi chip, a cellular radio, or other suitable communication interface.

As previously indicated, the lead assemblies 125 may be electrically coupled to the power platform 105A through the distribution board 115. That is, the lead assemblies 125 may be electrically coupled to the transformer 110 with the distribution board 115 electrically disposed between the lead assemblies 125 and the transformer 110 as described herein.

In some embodiments, the lead assemblies 125 may each include a feeder cable, one or more drop lines, one or more drop line connectors, and/or one or more in-line fuses. Alternatively, or additionally, the lead assemblies may include one or more load side breakers and/or in-line fuses, e.g., electrically coupled between the feeder cable and the drop lines, to electrically protect the drop lines and the chargers. Each lead assembly 125 may be configured to transmit the output power from the power platform 105A to the charger platforms 135 or return current from the charger platforms 135 to the power platform 105A. Example details regarding each lead assembly 125, including example components of each lead assembly 125 and associated operations are further disclosed in and discussed with respect to FIGS. 4 and 5 herein.

In some embodiments, the CMS 130 may extend from the power platform 105A to the charger platforms 135. A base of the power platform 105A and/or a base of the charger platform 135 may include cutouts and/or transition hoods to receive therein ends of one or more raceways included in the CMS 130. Alternatively, or additionally, the CMS 130 may extend between charger platforms 135 to support multiple charger platforms 135, and/or in anticipation of installation of additional charger platforms 135. The CMS 130 may be sized and shaped to receive two or more lead assemblies 125 and may provide at least one channel for the lead assemblies 125 to travel from the power platform 105A to the charger platforms 135. Additional channels or a single enlarged-capacity channel may be included in the CMS 130 to support additional lead assemblies 125 and/or other support cables and/or wires in the system 100A.

In some embodiments, the CMS 130 may extend from the power platform 105A to the charger platforms 135 or between charger platforms 135 in a continuous trajectory and/or on the same surface on which the power platform 105A is installed or located. For example, the CMS 130 may extend in a straight line on a surface (e.g., on or above ground) on which the power platform 105A is located, and from the power platform 105A to the charger platforms 135. Alternatively, or additionally, one or more raceways included in the CMS 130 may include corners, bends, curves, etc., in extending between the power platform 105A and the charger platforms 135. For example, the power platform 105A may be installed on a garage floor, the charger platform 135 may be disposed on the garage wall, and a raceway of the CMS 130 may include a bend, curve, 90-degree turn, or the like to transition from the garage floor to the garage wall. As another example, the CMS 130 may include two vertically-stacked 90-degree turns to route up and over a street curb, e.g., one transitioning from horizontal to vertical and the other transitioning from vertical to horizontal.

In these and other embodiments, the CMS 130 may be installed on various surfaces. For example, the CMS 130 may be affixed to a concrete pad, to an asphalt surface such as a parking lot, to the ground including grass, dirt, rock, etc., to walls, and/or ceilings (e.g., concrete walls or ceilings of parking garages, drywall and/or wood walls or ceilings of homes, etc.). The CMS 130 may be affixed to the various surfaces using various mechanical fasteners which may include, but not be limited to, screws, earth screws, masonry screws, bolts, lag bolts, anchors, concrete anchors, expanding anchors, nails, and the like.

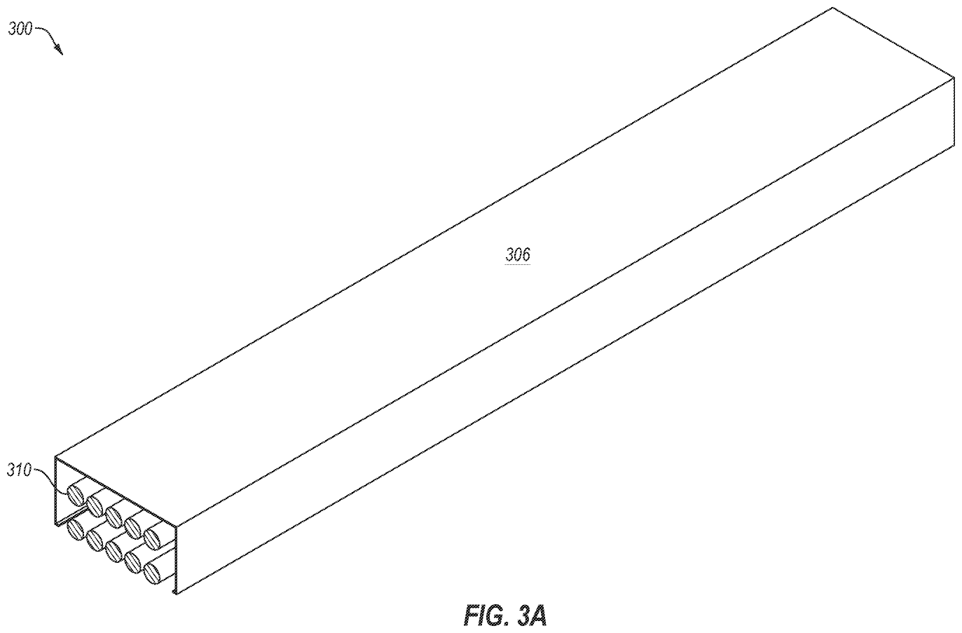

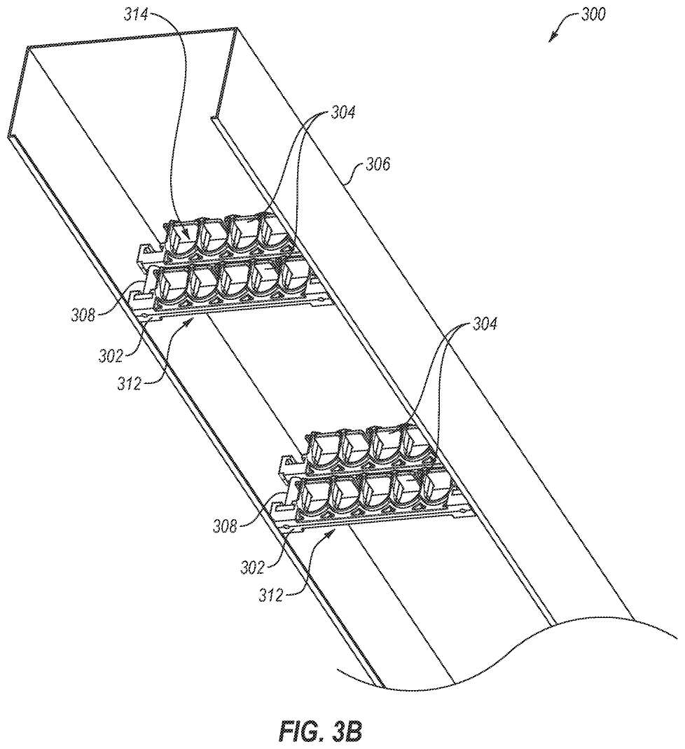

In some embodiments, the CMS 130 may include one or more raceways each made up of a base with a cover portion that may be hingedly attached to the base of the raceway. The hinged cover portion may enable access to an interior portion of the raceway, such as for providing service to the lead assemblies 125 disposed therein. In some embodiments, the CMS 130 may include one or more raceways, one or more multicable clips, one or more retention plates, and/or one or more risers. Each raceway may generally serve as a cover or housing that may be secured to one or more of the other components (e.g., the multicable clips) and/or to an installation surface to at least partially surround and protect the lead assemblies 125 and/or other components disposed therein. Additional details regarding example embodiments of CMS s which may be implemented herein are disclosed in U.S. patent application Ser. No. 18/295,830, filed Apr. 4, 2023, and titled MULTICABLE CLIP, which is incorporated herein by reference in its entirety for all purposes. In addition, some example details regarding an embodiment of the CMS 130 are disclosed in and discussed with respect to FIGS. 3A-3C herein.

In some embodiments, the charger platform 135 may include one or more EV chargers, such as four EV chargers. In some circumstances, it may be beneficial for the charger platform 135 to be located at an intersection of four parking stalls such that up to four EVs may charge from the charger platform 135. The EV chargers may be configured to deliver the output power from the power platform 105A to the electrically coupled EVs during a charging session.

In some embodiments, the EV chargers of the charger platform 135 may each be coupled to a drop line connector of the corresponding lead assembly 125. The drop line connector may be electrically coupled to a distal portion of the corresponding drop line, which drop line may in turn be electrically coupled to the feeder cable at an electrical nexus. In such configuration, the charger platform 135, and more particularly the EV charger(s) therein, may receive output power from the power platform 105A through the feeder cable, drop line, and drop line connector of one of the lead assemblies 125 and may return current through the drop line connector, drop line, and feeder cable of the other lead assembly 125.

Additional details regarding example embodiments of the system 100A and its components and which may be implemented herein are disclosed in U.S. application Ser. No. 18/309,766 filed on Apr. 28, 2023, which is incorporated herein by reference in its entirety for all purposes.

FIG. 1B illustrates a block diagram of another example EV charger system 100B (hereinafter “system 100B”), arranged in accordance with at least one embodiment described herein. The system 100B of FIG. 1B includes many of the same components as the system 100A of FIG. 1A which operate in the same or similar manner across the two systems 100A, 100B such that the associated description need not be repeated here. However, the system 100B includes, instead of the power platform 105A, an EV charger system power platform 105B (hereinafter “power platform 105B”). The power platform 105B generally operates in the same or similar manner as the power platform 105A and includes many of the same components as the power platform 105A which operate in the same or similar manner across the two power platforms 105A, 105B such that the associated description need not be repeated here. However, the power platform 105B omits the power meter 145. As a result, the functionality afforded by the power meter 145 may be absent from the power platform 105B and/or may be integrated into one or more of the other components of the power platform 105B.

FIG. 1C illustrates a block diagram of another example EV charger system 100C (hereinafter “system 100C”), arranged in accordance with at least one embodiment described herein. The system 100C of FIG. 1C includes many of the same components as the system 100A of FIG. 1A which operate in the same or similar manner across the two systems 100A, 100C such that the associated description need not be repeated here. However, the system 100C includes, instead of the power platform 105A, an EV charger system power platform 105C (hereinafter “power platform 105C”). The power platform 105C generally operates in the same or similar manner as the power platform 105A and includes many of the same components as the power platform 105A which operate in the same or similar manner across the two power platforms 105A, 105C such that the associated description need not be repeated here. However, the power platform 105C omits the transformer 110. As a result, the functionality afforded by the transformer 110 may be absent from the power platform 105C and/or may be integrated into one or more of the other components of the power platform 105C. In addition, the power meter 145 is shown in dashed lines in FIG. 1C to indicate that the power meter 145 is optional, i.e., the power meter 145 may be included in the power platform 105C or the power mater 145 may be omitted from the power platform 105C. In an example implementation of the power platform 105C in the system 100C of FIG. 1C, the input circuit 120 includes a 208 V panel on a QCB that does not involve or operate with a disconnect or the transformer 110.

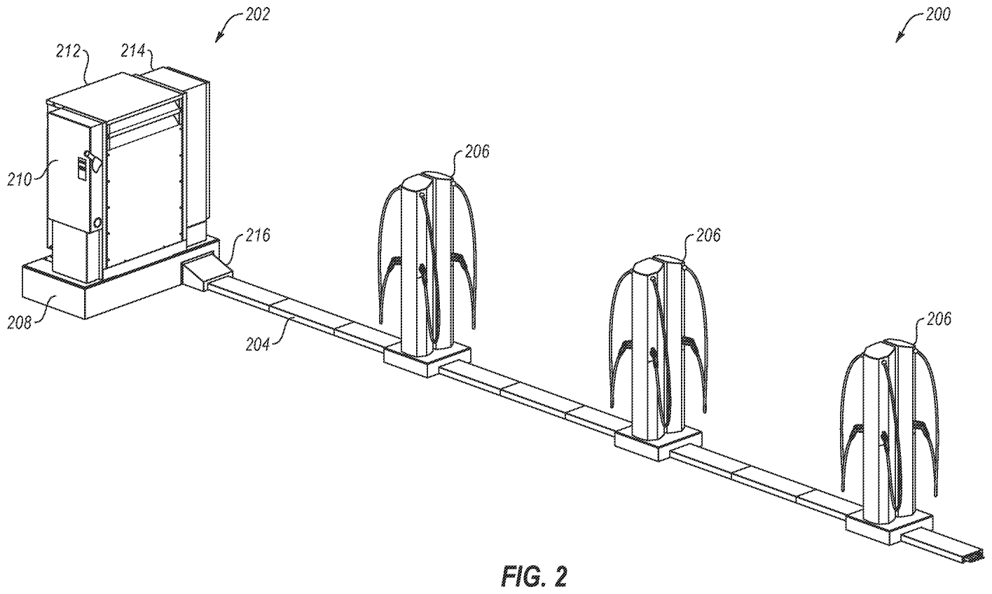

FIG. 2 is a perspective view of another example EV charger system 200 (hereinafter “system 200”) that includes an EV charger system power platform 202 (hereinafter “power platform 202”), a CMS 204, two or more lead assemblies and/or other wiring (not shown in FIG. 2), and one or more charger platforms 206, arranged in accordance with at least one embodiment described herein. The power platform 202 may be coupled to a power source (not shown), such as the power source 150 of FIG. 1A. The power platform 202 may be configured to transform power or otherwise condition power from the power source for compatibility with EV vehicles and/or the charger platforms 206. The power platform 202 includes a base or housing 208, a disconnect panel 210, a transformer 212, and a distribution board 214 that may respectively include, be included in, or correspond to the base or housing 107, the input circuit 120, the transformer 110, and the distribution board 115 of FIG. 1A. As illustrated, the system 200 further includes a transition hood 216 that couples the base 208 of the power platform 202 to the CMS 204.

The system 200 may include, be included in, or correspond to any of the systems 100A-100C (hereinafter generically “systems 100” or “system 100”) of FIGS. 1A-1C. For example, the power platform 202 may include, be included in, or correspond to any of the power platforms 105A-105C (hereinafter generically “power platforms 105” or “power platform 105”) of FIGS. 1A-1C, the CMS 204 may include, be included in, or correspond to the CMS 130 of FIGS. 1A-1C, the lead assemblies and/or other wiring (not shown in FIG. 2) may include, be included in, or correspond to the lead assemblies 125 of FIGS. 1A-1C, and/or the charger platforms 206 may include, be included in, or correspond to the charger platforms 135 of FIGS. 1A-1C.

The charger platforms 206 may be electrically coupled through the lead assemblies to the power platform 202. The CMS 204 may extend between the power platform 202 and at least one of the charger platforms 206 and/or between two charger platforms 206 to house and secure the lead assemblies.

FIGS. 3A-3B illustrate an example CMS 300, arranged in accordance with at least one embodiment described herein. The CMS 300 may include, be included in, or correspond to the CMS 204 of FIG. 2 and/or the CMS 130 of FIGS. 1A-1C. FIGS. 3A and 3B respectively include a top front perspective view and a bottom front perspective view of the CMS 300. As illustrated, the CMS 300 may include one or more multicable clips 302, one or more retention plates 304, a cable raceway 306 (which may include, be included in, or correspond to other raceways herein), and/or one or more risers 308. FIG. 3A additionally illustrates example feeder cables 310 that may be managed, protected, and/or housed by the CMS 300. The feeder cables 310 may be part of corresponding lead assemblies, such as the lead assemblies 125 of FIGS. 1A-1C, and/or may be the same as or similar to other feeder cables herein. Only one of the feeder cables 310 is labeled in FIG. 3A for simplicity. The feeder cables 310 are omitted from FIG. 3B for clarity.

Each multicable clip 302 includes multiple channels 314 (only one is labeled in FIG. 3B for simplicity) to receive and secure multiple feeder cables 310. For example, each of the multicable clips 302 illustrated in FIG. 3B includes five channels 314 to receive and secure five feeder cables 310. More generally, the number of channels 314 included in each multicable clip may be one or more. The retention plates 304 couple to the multicable clips 302 to retain the feeder cables 310 in the channels 314 after placement therein. As illustrated, each of the multicable clips 302 may be stacked with another multicable clip 302 through the risers 308. The risers 308 couple the multicable clips 302 together (optionally with one or more threaded fasteners or other fasteners).

A set of stacked multicable clips 302 together with corresponding retention plates 304 and risers 308 (and optional fasteners) may be referred to herein as a stacked retention assembly 312. Two stacked retention assemblies 312 are at least partially visible in FIG. 3B. The stacked retention assemblies 312 may be spaced apart along a length of the cable raceway 306 to provide support and management of the feeder cables 310 along the length of the cable raceway 306. For example, the stacked retention assemblies 312 may be spaced every 18 to 24 inches.

The cable raceway 306 may be configured to engage at least one of the multicable clips of each stacked retention assembly 312 along its length to at least partially enclose the stacked retention assemblies 312 (or portions thereof) and the feeder cables 310. For example, a retention flange or other structure of the cable raceway 306 may be configured to engage a shoulder or other structure defined in a bottom of each base multicable clip 302. Substitutions, modifications, additions, etc. may be made to FIGS. 3A-3B without altering the scope of the disclosure.

FIG. 4 illustrates a portion of a lead assembly 400, arranged in accordance with at least one embodiment described herein. The lead assembly 400 may include a feeder cable 405, electrical nexuses 410, drop lines 415, drop line connectors 420, and fuses 425. The lead assembly 400 may include, be included in, or correspond to other lead assemblies herein, such as the lead assemblies 125 of FIGS. 1A-1C. Similarly, the feeder cable 405, the electrical nexuses 410, the drop lines 415, the drop line connectors 420, and the fuses 425 may respectively include, be included in, or otherwise correspond to other feeder cables, electrical nexuses, drop lines, drop line connectors, and fuses herein.

At least one end of the feeder cable 405 may terminate in a feeder cable connector (not illustrated), which feeder cable connector may be configured to electrically and/or mechanically couple the feeder cable 405 to a power conversion device, such as the power platform 105 and/or to the distribution board 115 or other component of the power platform 105. In some embodiments, the feeder cable 405 may be electrically coupled to a jumper, which may be an “extension cord” device between the feeder cable 405 and the power conversion device which may be economical to use in some configurations, for example where portions of feeder cable 405 may be installed at different times. In another situation, the jumper could be buried underground and the feeder cable 405 could be installed above ground. Being able to install the feeder cable 405 and the jumper independent of one another can offer much more flexibility. The jumper could also be utilized if there are a significant number of varying lengths from charger platforms or EV chargers to the power conversion device. The jumper could also be utilized if there is a substantial distance (e.g., greater than 50 meters) to travel from charger platforms or EV chargers to the power conversion device and it may be wasteful to use the lead assembly 400 with unused drop lines 415. The other end of the feeder cable 405 may terminate in a most distal one of the electrical nexuses 410, which may be installed at the charger platform or EV charger located furthest from the power conversion device. In alternative embodiments, the feeder cable 405 includes a feeder cable connector at both terminal ends so feeder cables 405 can be connected one-to-another in an end-to-end orientation. In yet another embodiment, one or both ends of feeder cables 405 are blunt cut for subsequent manual connection, for example stripping and crimping to connectors or other segments of feeder cable 405.

Additional details regarding example embodiments of lead assemblies which may be implemented herein in connection with EV charger systems are disclosed in U.S. Pat. No. 10,992,254, as described above.

FIG. 5 illustrates a portion of another lead assembly 500, arranged in accordance with at least one embodiment described herein. The lead assembly 500 may include a feeder cable 505, an electrical nexus 510, and multiple drop lines 515.

As illustrated, the lead assembly 500 includes more than one drop line 515 coupled to the feeder cable 405 at the electrical nexus 510. Each drop line 515 electrically coupled to the feeder cable 405 may be electrically coupled to a charger platform or an EV charger. The lead assembly 500 and, in particular, the two drop lines 515, may support more than one charger platform or EV charger in close proximity to another charger platform or EV charger. For example, the two drop lines 515 may each electrically couple to a different charger platform or EV charger such that two charger platforms or EV chargers may be in close proximity to one another.

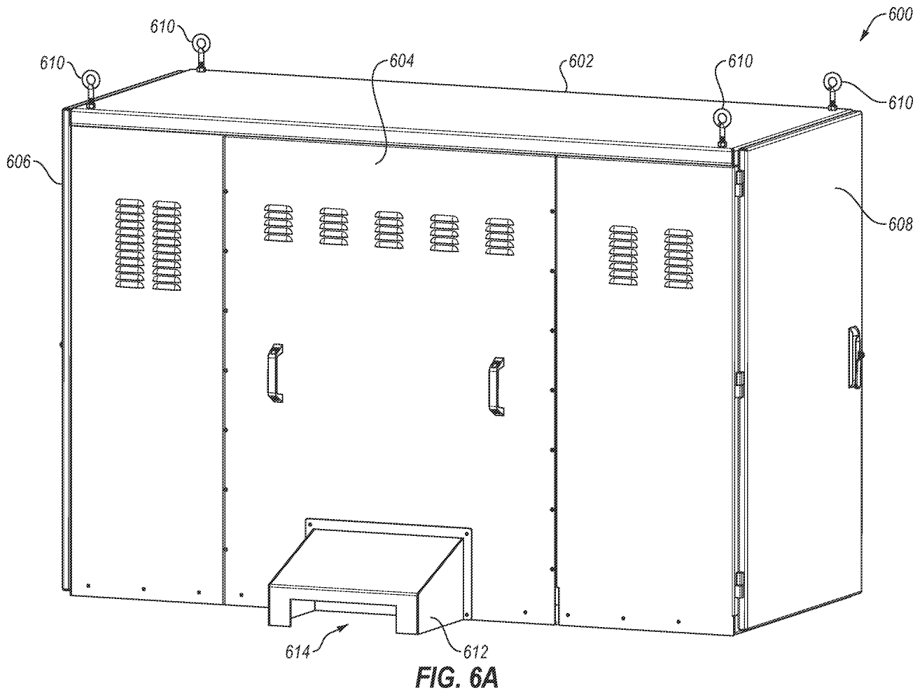

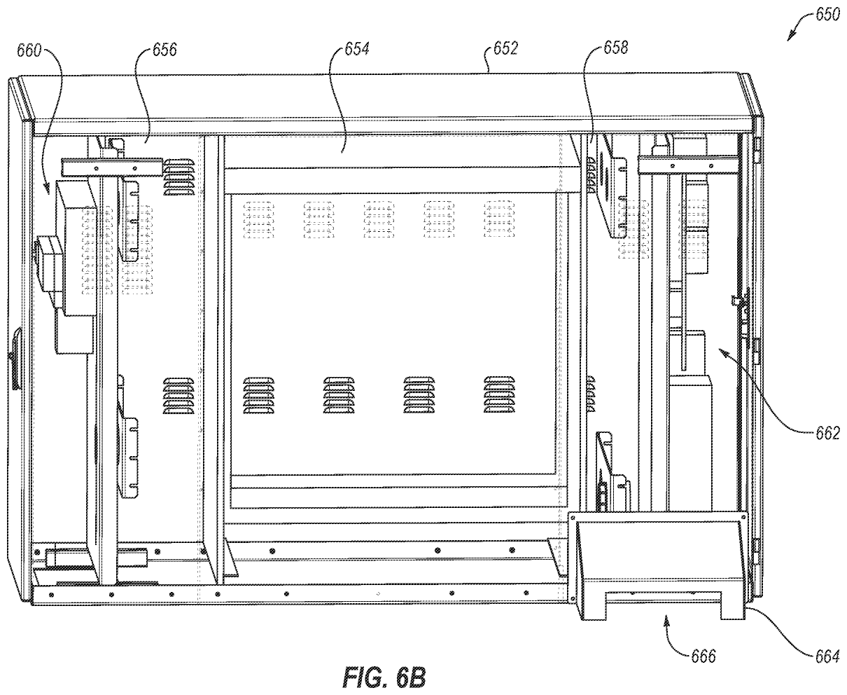

FIG. 6A is a perspective view of an EV charger system power platform 600 (hereinafter “power platform 600”), arranged in accordance with at least one embodiment described herein. The power platform 600 may include, be included in, or correspond to other power platforms described herein, such as any of the power platforms 105 of FIGS. 1A-1C. For example, the power platform 600 may include a housing 602 that may include, be included in, or correspond to other housings described herein, such as the housing 107 of FIGS. 1A-1C. The housing 602 encloses a volume within which other components of the power platform 600 may be disposed, such as one or more of a transformer, a distribution board, an electrical safety switch, a power meter, or a communication interface. In some embodiments, one or more of the components of the power platform 600, such as one or more of the transformer, the distribution board, the electrical safety switch, the power meter, and/or the communication interface, are or include custom components or components that are not off-the-shelf components.

The transformer, the distribution board, the electrical safety switch, the power meter, and the communication interface may respectively include, be included in, or correspond to the transformer 110, the distribution board 115, the input circuit 120, the power meter 145, and the communication interface 140 of FIGS. 1A-1C. In some embodiments, for example, the transformer may be disposed within the volume defined by the housing 602 and may be configured to be electrically coupled to a power source (not shown in FIG. 6) and to generate output power from input power received from the power source. The distribution board may be disposed within the volume and may be electrically coupled to an output of the transformer. The electrical safety switch may be disposed within the volume and may be electrically coupled to an input of the transformer and may be configured to be electrically coupled to the power source. The power meter, if included, may be disposed within the volume and may be electrically coupled between the transformer and the distribution board. The communication interface, if included, may be disposed within the volume and may be configured to communicatively couple the power platform 600 to a communication network.

The volume enclosed by the housing 602 may be or include a common undivided volume within which the transformer, the distribution board, and the electrical safety switch (and/or other components of the power platform 600) may be positioned. That is, in some embodiments, none of the transformer, the distribution board, or the electrical safety switch is a modular component or is part of a modular component that is wholly enclosed within its own housing or other housing positioned within the housing 602. In other embodiments, the volume enclosed by the housing 602 may be divided internally with fixed or removable panels, e.g., to at least partially separate the transformer, the distribution board, and the electrical safety switch from each other and/or from other components of the power platform 600.

In these and other embodiments, the various components of the power platform 600 may be electrically coupled together without requiring the use of any conduit between the components. For example, the transformer may be electrically coupled to the distribution board without the electrical connection or coupling between the transformer and the distribution board passing through any conduit. As another example, the transformer may be electrically coupled to the electrical safety switch without the electrical connection or coupling between the transformer and the electrical safety switch passing through any conduit.

In some embodiments, the housing 602 may include one or more of a transformer access panel 604, a distribution board access panel 606, an electrical safety switch access panel 608, and/or other access panel(s). In general, the various access panels 604, 606, 608 may be removable and/or openable to allow access to one or more components within the volume defined by the housing 602. For example, the transformer access panel 604 may be proximate to the transformer within the volume so that when the transformer access panel 604 is opened or removed from the housing 602, the transformer may be accessed, e.g., for service, testing, or the like. As another example, the distribution board access panel 606 may be proximate to the distribution board within the volume so that when the distribution board access panel 606 is opened or removed from the housing 602, the distribution board may be accessed, e.g., for service, testing, or the like. As another example, the electrical safety switch access panel 608 may be proximate to the electrical safety switch within the volume so that when the electrical safety switch access panel 608 is opened or removed from the housing 602, the electrical safety switch may be accessed, e.g., for service, testing, or the like.

In some embodiments, the power platform 600 may further include one or more lift bolts 610, such as eye bolts, that extend from the top of the housing 602. The lift bolts 610 may be configured to collectively support a weight of the power platform 600. The power platform 600 may include an frame around which the housing 602 may be built and to which the lift as bolts 610 may be coupled. Alternatively, the housing 602 itself may incorporate a frame and/or be sufficiently strong structurally to support the weight of the power platform 600 through the lift bolts 610 coupled to the housing 602.

The lift bolts 610 may allow the power platform 600 to be lifted from above, e.g., by one or more straps connected to the lift bolts 610 and suspended from a forklift, thereby allowing the power platform 600 to be positioned at an installation site with the assistance of one or more individuals pushing or pulling on the suspended power platform 600. In comparison, individuals may be unable to assist positioning a power platform that is lifted from below (e.g., by a forklift lifting against a base of the power platform) due to the size of the power platform and friction between the power platform and the forklift.

In some embodiments, instead of or in addition to the lift bolts 610, the power platform 600 may include two pass throughs or fork pockets, e.g., formed in a base of the power platform 600. The pass throughs or fork pockets may be configured to receive therethrough or therein forks of a forklift to lift the power platform 600 generally from the bottom.

The power platform 600 may be part of an EV charger system, such as the systems 100, 200 or other EV charger systems described herein. In this and other embodiments, the EV charger system may further include a transition hood 612 that defines a transition volume 614 that extends from the volume enclosed by the housing 602, and particularly in the illustrated embodiment from the transformer access panel 604. The transition hood 612 may cooperate with one or more other components or surfaces (such as an installation surface on which the power platform 600 is installed) to define the transition volume 614 or may define the transition volume 614 on its own. The EV charger system may further include one or more lead assemblies (such as the lead assemblies 125) or other electrical lines extending from an output of the distribution board of the power platform 600, through the volume enclosed by the housing 602, and through the transition volume 614 to, e.g., one or more EV charger platforms (such as the charger platforms 135). Alternatively or additionally, the EV charger system may further include one or more raceways and/or other CMS components (such as the raceway 306) that at least partially enclose and/or protect the lead assemblies extending between the power platform 600 and the EV charger platform(s). In some embodiments, the raceway extends from the transition hood 612 to define a raceway volume that extends from the transition volume, the lead assemblies extending through the raceway volume, e.g., to or at least toward the charger platform.

FIG. 6B is a perspective view of another EV charger system power platform 650 (hereinafter “power platform 650”), arranged in accordance with at least one embodiment described herein. The power platform 650 may be the same as or similar to the power platform 600 of FIG. 6A with the following differences. The power platform 650 may include a housing 652 with a transformer access panel 654, an electrical safety switch access panel 656, and a distribution board access panel 658. Each of the transformer access panel 654, the electrical safety switch access panel 656, and the distribution board access panel 658 is depicted in FIG. 6B as being transparent for illustration purposes. The transparency permits a back panel 660 that includes the electrical safety switch as well as the distribution board, designated at 662 in FIG. 6B, to be seen behind the corresponding access panel 656 or 658. The transformer has been omitted from FIG. 6A.

FIG. 6B illustrates a transition hood 664 that defines a transition volume 666. The transition hood 664 and the transition volume 666 are similar or identical to the transition hood 612 and the transition volume 614 of FIG. 6A except that in FIG. 6B, the transition hood 664 extends from the distribution board access panel 658 (versus the transformer access panel 604 in FIG. 6A).

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

ddd

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An electric vehicle (EV) charger system power platform, the power platform comprising:
a housing that encloses a volume;
a transformer disposed within the volume, the transformer configured to be electrically coupled to a power source and to generate output power from input power received from the power source;
a distribution board disposed within the volume and electrically coupled to an output of the transformer; and
an electrical safety switch disposed within the volume and electrically coupled to an input of the transformer and configured to be electrically coupled to the power source.

2. The power platform of claim 1, wherein the transformer is electrically coupled to the distribution board without any conduit between the transformer and the distribution board and wherein the transformer is electrically coupled to the electrical safety switch without any conduit between the transformer and the electrical safety switch.

3. The power platform of claim 1, wherein the transformer, the distribution board, and the electrical safety switch comprise custom components electrically coupled together within the volume.

4. The power platform of claim 1, wherein the volume comprises a common undivided volume within which the transformer, distribution board, and electrical safety switch are positioned.

5. The power platform of claim 1, wherein the housing includes:
a transformer access panel proximate the transformer to access the transformer within the volume;
a distribution board access panel proximate the distribution board to access the distribution board within the volume; and
an electrical safety switch access panel proximate the electrical safety switch to access the electrical safety switch within the volume.

6. The power platform of claim 1, further comprising one or more lift bolts extending from a top of the housing and configured to collectively support a weight of the power platform.

7. The power platform of claim 1, wherein the transformer, the distribution board, and the electrical safety switch are electrically coupled together via one or more electrical lines.

8. The power platform of claim 1, wherein the distribution board includes an electrical switch having an open configuration and a closed configuration, wherein in the open configuration, a load is electrically decoupled from the power platform, and in the closed configuration, the load is electrically coupled to the power platform.

9. The power platform of claim 1, wherein the electrical safety switch includes an electrical switch having an open configuration and a closed configuration, wherein in the open configuration, the transformer is electrically decoupled from the power source, and in the closed configuration, the transformer is electrically coupled to the power source.

10. The power platform of claim 1, wherein the output power is a direct current (DC) power or an alternating current (AC) power.

11. The power platform of claim 1, further comprising a power meter electrically coupled between the transformer and the distribution board.

12. The power platform of claim 1, further comprising a communication interface configured to communicatively couple the power platform to a communication network.

13. An electric vehicle (EV) charger system, comprising: the power platform of claim 1; and
a transition hood coupled to the housing, the transition hood defining a transition volume that extends from the volume enclosed by the housing.

14. The EV charger system of claim 13, further comprising one or more lead assemblies extending from an output of the distribution board, through the volume enclosed by the housing, and through the transition volume.

15. The power platform of claim 14, further comprising a raceway that extends from the transition hood to define a raceway volume that extends from the transition volume, the one or more lead assemblies extending through the raceway volume.

16. A method comprising:
positioning a transformer within a volume enclosed by a housing of an electric vehicle (EV) charger system power platform at an assembly site that is different than an installation site of the EV charger system power platform;
positioning a distribution board within the volume at the assembly site;
electrically coupling the distribution board to an output of the transformer at the assembly site; and
positioning an electrical safety switch within the volume at the assembly site;
electrically coupling the electrical safety switch to an input of the transformer at the assembly site,
wherein the housing, the transformer, the distribution board, and the electrical safety switch collectively form the EV charger system power platform.

17. The method of claim 16, further comprising:
transporting the EV charger system power platform to the installation site; and
installing the EV charger system power platform at the installation site.

18. The method of claim 16, wherein installing the EV charger system power platform at the installation site includes:
electrically coupling the EV charger system power platform to a power source; and
mechanically coupling the EV charger system power platform to the installation site.

19. The method of claim 18, wherein mechanically coupling the EV charger system power platform to the installation site includes mechanically coupling the EV charger system power platform to a surface and/or structure at the installation site using at least one of screws, earth screws, masonry screws, bolts, lag bolts, anchors, concrete anchors, expanding anchors, or nails.

20. The method of claim 16, further comprising at least one of:
positioning a power meter within the volume and electrically coupling the power meter between the transformer and the distribution board at the assembly site; or
positioning a communication interface within the volume and communicatively coupling the communication interface to the EV charger system power platform at the assembly site.
